(19) United States
(12) Patent Application Publication
(10) Pub. No.: US 2021/0211303 A1
(43) Pub. Date: Jul. 8, 2021

(54) SIGNATURE DEVICE, VERIFICATION DEVICE, SIGNATURE SYSTEM, SIGNATURE METHOD, VERIFICATION METHOD, AND COMPUTER READABLE MEDIUM

(71) Applicant: MITSUBISHI ELECTRIC CORPORATION, Tokyo (JP)

(72) Inventor: Ryo HIROMASA, Tokyo (JP)

(73) Assignee: MITSUBISHI ELECTRIC CORPORATION, Tokyo (JP)

(21) Appl. No.: 17/209,966

(22) Filed: Mar. 23, 2021

Related U.S. Application Data
(63) Continuation of application No. PCT/JP2018/036338, filed on Sep. 28, 2018.

(51) Int. Cl. H04L 9/32; H04L 9/06; H04L 9/30; G06N 10/00

(52) U.S. Cl. CPC H04L 9/3247; H04L 9/0643; G06N 10/00; H04L 9/3093; H04L 9/3236

(57) ABSTRACT

A key generation device (10) generates a pair of a secret key sk including an element s₁ and a public key pk including an element a and an element t₁. A signature device (20) generates a signature element z, which is an element of a signature σ, by computing a middle-product of a hash value c of a message β and the element s₁ of the secret key sk. A verification device (30) verifies the signature σ by computing a middle-product of the signature element z, which is an element of the signature σ, and the element a of the public key pk, and computing a middle-product of the hash value c, which is an element of the signature 6, and the element t₁ of the public key pk.

### CROSS REFERENCE TO RELATED APPLICATIONS

This application is a Continuation of PCT International Application No. PCT/JP2018/036338, filed on Sep. 28, 2018, which is hereby expressly incorporated by reference into the present application.

### TECHNICAL FIELD

The present invention relates to a digital signature that takes a quantum computer into consideration.

### BACKGROUND ART

A digital signature is a cryptographic technique that can verify the validity of data.

When communication is performed via a network, it is necessary to make it possible to ascertain the validity of data, which means that received data is truly the data sent from its sender and that the received data is data that has not been tampered with.

The validity of data can be verified by arranging that a signature be attached to the data by a sender and verifying the signature attached to the data by a receiver.

Lattice-based cryptography is a cryptographic technique that is realized using a lattice, which is a set of vectors represented by linear transformations of linearly independent integer vectors.

The shortest vector problem for a certain lattice is a problem of finding the shortest vector included in that lattice. The security of lattice-based cryptography is based on the hardness of solving the shortest vector problem even for a quantum computer. Therefore, lattice-based cryptography is one of cryptographic schemes considered to be secure even if a quantum computer is realized.

The security of efficient lattice-based cryptography is based on the shortest vector problem over special lattices called ideal lattices. It is known that due to the properties of cyclotomic polynomials, which are polynomials defining ideal lattices, the shortest vector problem is efficiently solved by a quantum computer in specific parameters.

Non-Patent Literature 1 presents an efficient digital signature scheme whose security is based on the shortest vector problem over ideal lattices. However, the security of the scheme presented in Non-Patent Literature 1 is based on the shortest vector problem over lattices defined by a specific cyclotomic polynomial and thus may not be secure.

Non-Patent Literature 2 presents an efficient digital signature scheme whose security is based on the shortest vector problem over lattices not dependent on a specific cyclotomic polynomial.

### CITATION LIST

### Non-Patent Literature

Non-Patent Literature 1: Leo Ducas, Eike Kiltz, Tancrede Lepoint, Vadim Lyubashevsky, Peter Schwabe, Gregor Seiler, and Damien Stehle. CRYSTALS-Dilithium: A Lattice-Based Digital Signature Scheme. In CHES, pages 238-268, 2018.

Non-Patent Literature 2: Vadim Lyubashevsky. Digital Signatures Based on the Hardness of Ideal Lattice Problems in all Rings. In ASIACRYPT, pages 196-214, 2016.

### SUMMARY OF INVENTION

### Technical Problem

The digital signature scheme presented in Non-Patent Literature 2 is not shown to be secure in a security model in which a quantum computer computes a hash function. In digital signature schemes whose security is based on the shortest vector problem over lattices, a hash function is computed to generate a digital signature. Therefore, in order to consider the security against a quantum computer in a strict sense, it is desirable that the security be shown even in a model in which a quantum computer computes a hash function.

It is an object of the present invention to allow construction of a digital signature scheme whose security can be guaranteed even against a quantum computer.

### Solution to Problem

A signature device according to the present invention includes a signature generation unit to generate a signature element z by computing a middle-product of a hash value c of a message μ and a secret key; and an output unit to output a signature 6 including the signature element z generated by the signature generation unit.

### Advantageous Effects of Invention

In the present invention, a signature element z is generated by computing a middle-product of a hash value c of a message β and a secret key. This allows construction of a digital signature scheme which can be shown to be secure in a security model in which a quantum computer computes a hash function.

### BRIEF DESCRIPTION OF DRAWINGS

FIG. 1 is a configuration diagram of a signature system 1 according to a first embodiment;

FIG. 2 is a configuration diagram of a key generation device 10 according to the first embodiment;

FIG. 3 is a configuration diagram of a signature device 20 according to the first embodiment; FIG. 4 is a configuration diagram of a verification device 30 according to the first embodiment;

FIG. 5 is a flowchart of operation of the key generation device 10 according to the first embodiment;

FIG. 6 is a flowchart of a key generation process according to the first embodiment;

FIG. 7 is a flowchart of operation of the signature device 20 according to the first embodiment;

FIG. 8 is a flowchart of a signature generation process according to the first embodiment;

FIG. 9 is a flowchart of operation of the verification device 30 according to the first embodiment;

FIG. 10 is a configuration diagram of the key generation device 10 according to a first variation;

FIG. 11 is a configuration diagram of the signature device 20 according to the first variation; and

FIG. 12 is a configuration diagram of the verification device 30 according to the first variation.

### DESCRIPTION OF EMBODIMENTS

### First Embodiment

Description of Configurations

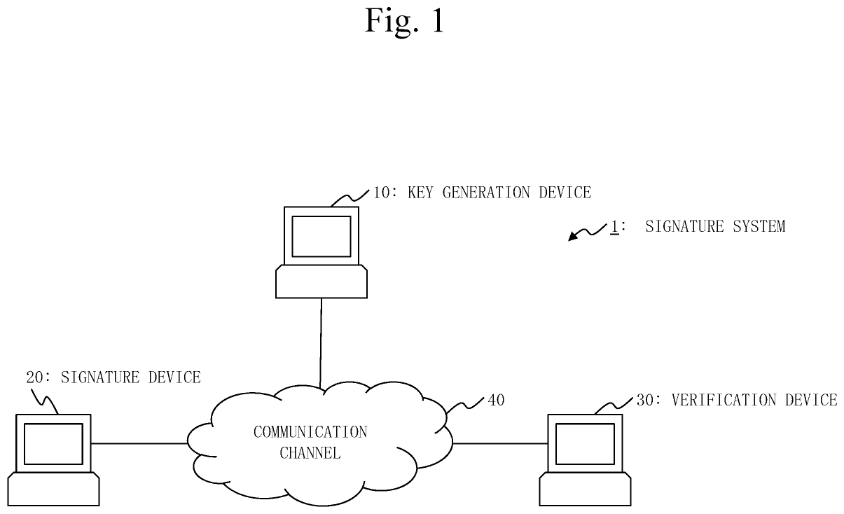

Referring to FIG. 1, a configuration of a signature system 1 according to a first embodiment will be described.

The signature system 1 includes a key generation device 10, a signature device 20, and a verification device 30. The key generation device 10, the signature device 20, and the verification device 30 are connected via a communication channel 40 such as the Internet. The communication channel 40 is not limited to the Internet and may be another type of communication channel such as a local area network (LAN).

The key generation device 10 is a computer such as a personal computer (PC). The key generation device 10 generates a public key and a secret key that are used for encryption, and transmits the secret key to the signature device 20 and transmits the public key to the verification device 30, via the communication channel 40.

The signature device 20 is a computer such as a personal computer (PC). The signature device 20 generates signature data by generating a signature for plaintext data such as document data stored in the computer, using a stored secret key, and transmits the signature data and the plaintext data to the verification device 30.

The verification device 30 is a computer such as a personal computer (PC). The verification device 30 generates verification result data concerning the signature data for the plaintext data, using the plaintext data and the signature data received from the signature device 20 and the public key received from the key generation device 10.

Any two or more of the key generation device 10, the signature device 20, and the verification device 30 may be included together in the same computer.

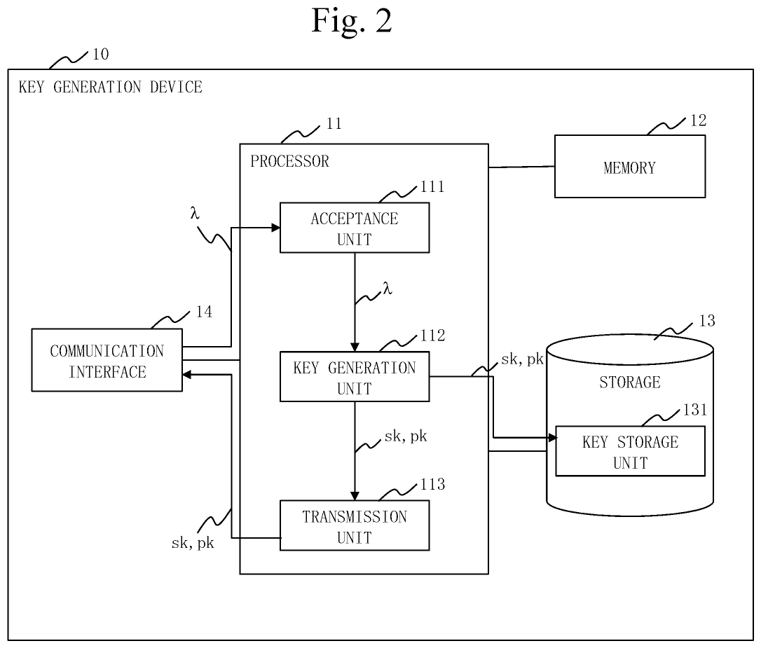

Referring to FIG. 2, a configuration of the key generation device 10 according to the first embodiment will be described.

The key generation device 10 includes hardware of a processor 11, a memory 12, a storage 13, and a communication interface 14. The processor 11 is connected with the other hardware components via signal lines and controls the other hardware components.

The key generation device 10 includes, as functional components, an acceptance unit 111, a key generation unit 112, and a transmission unit 113. The functions of the functional components of the key generation device 10 are realized by software.

The storage 13 stores programs for realizing the functions of the functional components of the key generation device 10. These programs are loaded into the memory 12 by the processor 11 and executed by the processor 11. This realizes the functions of the functional components of the key generation device 10.

The storage 13 realizes the function of a key storage unit 131.

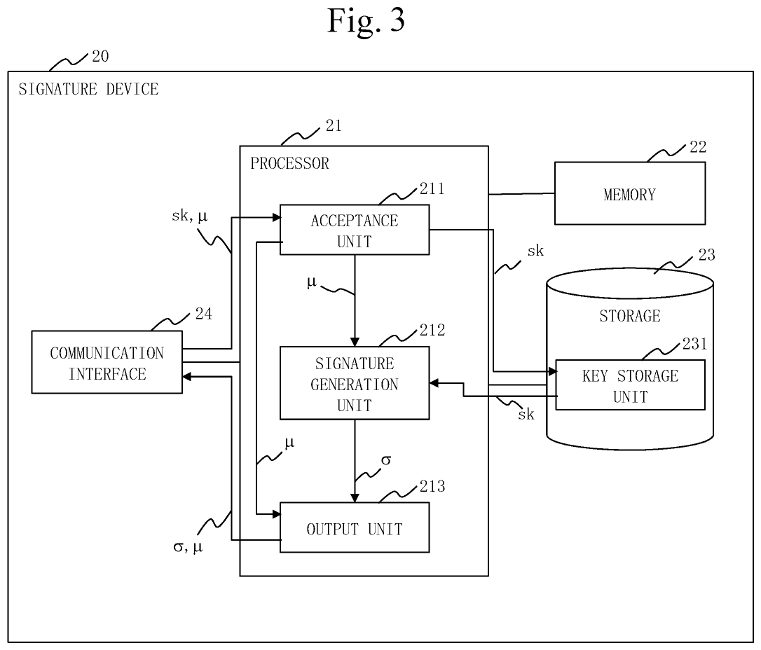

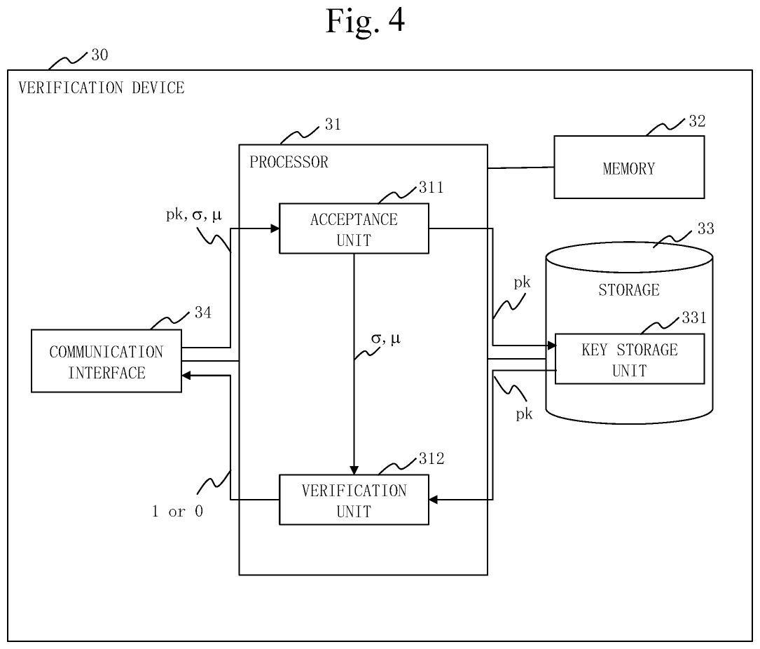

Referring to FIG. 3, a configuration of the signature device 20 according to the first embodiment will be described.

The signature device 20 includes hardware of a processor 21, a memory 22, a storage 23, and a communication interface 24. The processor 21 is connected with the other hardware components via signal lines and controls the other hardware components.

The signature device 20 includes, as functional components, an acceptance unit 211, a signature generation unit 212, and an output unit 213. The functions of the functional components of the signature device 20 are realized by software.

The storage 23 stores programs for realizing the functions of the functional components of the signature device 20. These programs are loaded into the memory 22 by the processor 21 and executed by the processor 21. This realizes the functions of the functional components of the signature device 20.

The storage 23 realizes the function of a key storage unit 231.

Referring to FIG. 4, a configuration of the verification device 30 according to the first embodiment will be described.

The verification device 30 includes hardware of a processor 31, a memory 32, a storage 33, and a communication interface 34. The processor 31 is connected with the other hardware components via signal lines and controls the other hardware components.

The verification device 30 includes, as functional components, an acceptance unit 311 and a verification unit 312. The functions of the functional components of the verification device 30 are realized by software.

The storage 33 stores programs for realizing the functions of the functional components of the verification device 30. These programs are loaded into the memory 32 by the processor 31 and executed by the processor 31. This realizes the functions of the functional components of the verification device 30.

The storage 33 realizes the functions of a key storage unit 331 and a result storage unit 332.

Each of the processors 11, 21, and 31 is an integrated circuit (IC) that performs arithmetic processing. As a specific example, each of the processors 11, 21, and 31 is a central processing unit (CPU), a digital signal processor (DSP), or a graphics processing unit (GPU).

Each of the memories 12, 22, and 32 is a storage device to temporarily store data. As a specific example, each of the memories 12, 22, and 32 is a static random access memory (SRAM) or a dynamic random access memory (DRAM).

Each of the storages 13, 23, and 33 is a storage device to store data. As a specific example, each of the storages 13, 23, and 33 is a hard disk drive (HDD). Alternatively, each of the storages 13, 23, and 33 may be a portable storage medium such as a Secure Digital (SD, registered trademark) memory card, CompactFlash (CF, registered trademark), a NAND flash, a flexible disk, an optical disc, a compact disc, a Blu-ray (registered trademark) disc, or a digital versatile disk (DVD).

Each of the communication interfaces 14, 24, and 34 is an interface for communicating with external devices. As a specific example, each of the communication interfaces 14, 24, and 34 is an Ethernet (registered trademark) port, a Universal Serial Bus (USB) port, or a High-Definition Multimedia Interface (HDMI, registered trademark) port.

FIG. 2 illustrates only one processor 11. However, the key generation device 10 may include a plurality of processors as an alternative to the processor 11.

Similarly, the signature device 20 may include a plurality of processors as an alternative to the processor 21. The verification device 30 may include a plurality of processors as an alternative to the processor 31.

The plurality of processors share execution of the programs for realizing the functions of the respective functional components. Each of the plurality of processors is, like the processors 11, 21, and 31, an IC that performs arithmetic processing.

Description of Operation

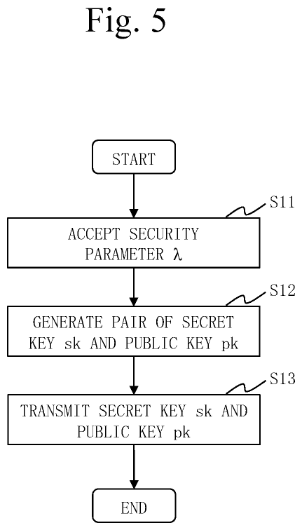

Referring to FIGS. 5 to 9, operation of the signature system 1 according to the first embodiment will be described.

The operation of the signature system 1 according to the first embodiment corresponds to a signature method according to the first embodiment. The operation of the signature system 1 according to the first embodiment also corresponds to processes of a signature program according to the first embodiment.

Preliminaries

Information necessary for describing the operation of the signature system 1 according to the first embodiment will be described.

<Notations>

Notations to be used in the following description will be described. Formula 11 denotes a set of natural numbers, and Formula 12 denotes a set of integers. In the text below, a set of natural numbers is denoted as N and a set of integers is denoted as Z.

[Formula 11] [symbol]
[Formula 12]

[symbol]

For any integers a and b, (a, b) denotes the set indicated in Formula 13, and [a, b] denotes the set indicated in Formula 14.

x ∈ [symbol] s.t. α<x<b [Formula 13]

x ∈ [symbol] s.t. α≤x≤b [Formula 14]

For any positive integer d>0, [d] denotes a set {1, 2, . . . , d}.

Let S be a certain set and P be a probability distribution over the set S. Formula 15 denotes that a ∈ S is chosen uniformly at random from the set S. Formula 16 denotes that b ∈ S is chosen according to the probability distribution P.

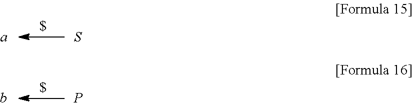

Note that negl(λ) denotes a set of functions that can be neglected for a natural number λ.

<Digital Signature>

A digital signature is composed of three algorithms: a KeyGen algorithm, a Sign algorithm, and a Verify algorithm.

The KeyGen algorithm takes as input a security parameter λ, and outputs a pair of a secret key sk and a public key pk (sk, pk).

The Sign algorithm takes as input the secret key sk and a message μ, and outputs a signature σ.

The Verify algorithm takes as input the public key pk, the message μ, and the signature σ, and outputs 1 if the signature σ is a valid signature for the message μ and outputs 0 otherwise.

<Middle-Product Learning With Errors (MPLWE)>

MPLWE is described in this document (Miruma Rosca, Amin Sakzad, Damien Stehle, and Ron Steinfeld. Middle-Product Learning with Errors. In CRYPTO, pages 283-297, 2017).

Let R^{′k} denote a set of polynomials with coefficients in Z and let R_{q}^{≤k} denote a set of polynomials with coefficients in Z_{q}, each of degree at most k−1>0. An L_{∞} norm and an L₂ norm of a polynomial r are denoted as indicated in Formula 17.

∥r∥_{∞}, ∥r∥₂ [Formula 17]

For a natural number a, a set of elements w satisfying Formula 18 is denoted as Sa^{<k}.

∥w∥_{∞}≤α [Formula 18]

For a certain polynomial r₀+r₁ₓ+ . . . + rk−1x^{k-1} ∈ R^{<k}(or r ∈ S^{<k}), the notation of Formula 19 is used.

r=(r₀, r₁, . . . , rₖ₋₁),

r̅=(rₖ₋₁, rₖ₋₂, . . . , r₀) [Formula 19]

For a vector r ∈ Z^{k}, r[i:j] (0<i<j<k) denotes a vector with the i-th to j-th coefficients in r.

(Definition of Toeplitz Matrix)

For any d, k>0 and a ∈ R^{<k}, a matrix in R^{d×(k+d-1)} whose i-th row (i=1, . . . , d) is a coefficient vector of xⁱ⁻¹·a is denoted as Toepd^{d,k}(a) and is called a Toeplitz matrix.

(Definition of Middle-Product)

Let dₐ, d_{b}, d, and k be integers that satisfy dₐ+d_{b}−1=d+2k. The map of the middle-product indicated in Formula 20 is the map indicated in Formula 21.

middle-product ⊙_{d}:R^{<d}^{ₐ}×R^{<d}^{_{b}}→R^{<d} [Formula 20]

$$( a , b ) ↦ a {⊙}_{d} b = ⌊ \frac{a \cdot {b mod x}^{k + d}}{{x}^{k}} ⌋ \qquad [ Formula 21 ]$$

For all da and db such that dₐ+d_{b}−1−d is non-negative and even, the notation indicated in Formula 22 is used.

⊙d [Formula 22]

The middle-product can be expressed using the Toeplitz matrix, as described below. The product of the Toeplitz matrix and a vector can be computed with O(nlogn).

(Lemma 1)

Let d, k>0. Formula 23 is assumed.

r∈R^{<k+1},

α∈ R^{k+d},

b:=r⊙d α [Formula 23]

In this case, Formula 24 holds.

b̅:=Toep^{d,k+1}(r)·ā [Formula 24]

(Corollary 1)

Formula 24 can be converted as indicated in Formula 25.

b=Ar̅,

A=[α[1;k+1]∥α[2;k+2]∥ . . . ∥α[d;k+d]]^{T} [Formula 25]

For polynomials with corresponding dimensions, the middle-product and the product of the polynomials satisfy the following property like the associative law.

### (Lemma 2)

Let d, k, n>0. For all r ∈ R^{<k+1}, a ∈ R^{<n}, and s ∈ R^{<n+s+k-1}, Formula 26 holds.

r⊙_{d}(a⊙_{d+k}^{s})=(r·a)⊙_{d}s

For polynomials with the same degree as in Lemma 2, the middle-product has a partial commutative property, and this can be shown based on a commutative property of the product of the polynomials.

### (Corollary 2)

For the same r ∈ R^{<k+1}, a ∈ R^{<n}, and s ∈ R^{<n+d+k-1} as in Lemma 2, Formula 27 holds.

r⊙_{d}(a⊙_{d+k}s)=a⊙_{d}(r⊙_{d+n-1}s) [Formula 27]

(Definition of MPLWE Distribution)

Let n, d>0, q≥2, and x be a distribution over R^{<d}. For s ∈ Z, a distribution MPLWE_{q,n,d,x}(s) over Z_{q}^{<n}[x]×R_{q}^{<d} is a distribution that samples a and e as indicated in

Formula 28, and returns Formula 29.

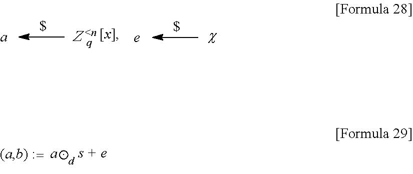

The definition of a decision MPLWE problem will be described. An MPLWE problem is a problem of distinguishing between elements sampled from an MPLWE distribution and elements sampled from a uniform distribution. A decision MPLWE assumption is an assumption that it is difficult to solve the MPLWE problem with any efficient algorithm.

(Definition of MPLWE Problem)

Let n, d>0, q≥2, and x be a distribution over R^{<d}. An MPLWE_{n,d,q,x} problem is a problem of distinguishing between an arbitrary number of samples from MPLWE_{n,d,q,x}(s) and the same number of samples from Z_{q}^{<n}[x]×R_{q}^{<d}.

For any attacker A, the advantage of the attacker A concerning the

MPLWE_{n,d,q,x} problem is defined as indicated in Formula 30.

$${Adv}_{A}^{{MPLWE}_{n , d , q , χ}} ( λ ) := \vert \begin{matrix}Pr [ 1 ← A ( a , t ) : ( a , t ) {}^{\$} {MPLWE}_{n , d , q , χ} ( s ) ] \\ - PR [ 1 ← A ( a , t ) : ( a , t ) {}^{\$} {R}_{q}^{< n} \times {R}_{q}^{< d} ]\end{matrix} \vert \qquad [ Formula 30 ]$$

Note that probabilities are obtained over Formula 31 and random numbers of the attacker.

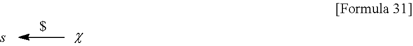

If it is difficult to solve the MPLWE_{n,d,q,x}(s) problem for any probabilistic polynomial-time algorithm A, that is, if AdvA^{MPLWE}(λ)=negl(λ), the MPLWE assumption is said to be established.

<Associated Algorithms>

Algorithms used in the digital signature realized by the signature system 1 according to the first embodiment will be described.

(Notations)

Notations used in the algorithms will be described.

For any integer r and any even (or odd) integer α>0, let r′=r mod^{±} α be a unique element r′ ∈ (−α/2, α/2] (r′ ∈ [−(α−1)/2, (α−1)/2) if the integer α is odd) that satisfies r′=r mod α. Let r′=r mod⁺ α be a unique integer r′ ∈ [0, α) that satisfies r′ =r mod α.

Formula 32 denotes a bit that is 1 if B is true and 0 otherwise.

### [Formula 32]

[symbol] B

[symbol]

(Algorithms)

These algorithms are described in this document (Leo Ducas, Eike Kiltz, Tancrede Lepoint, Vadim Lyubashevsky, Peter Schwabe, Gregor Seiler, and Damien Stehle. CRYSTALS−Dilithium: A Lattice-based Digital Signature Scheme. In CHES, pages 238-268, 2018).

The algorithms are defined over integers. However, the algorithms can be easily generalized also for polynomials by applying the algorithms to each coefficient.

(Prower2Round_{q}(r, d) algorithm)

A Prower2Round_{q}(r, d) algorithm is an algorithm that outputs high-order bits obtained by breaking up r by 2^{d}.

Specifically, in the Prower2Round_{q}(r, d) algorithm, r:=r mod⁺ q is computed and r₀:=r mod^{±}2^{d} is further computed. Then, (r-r₀)/2d is output.

(Decompose_{q} (r, α) algorithm)

A Decompose_{q}(r, α) algorithm is an algorithm that outputs high-order bits r₁ and low-order bits ro obtained by breaking up r by α.

Specifically, in the Decompose_{q}(r, α) algorithm, r:=r mod⁺ q is computed and r₀:=r mod^{±} α is further computed. If r−r₀=−1, r₁:=0 is set and r₀:=r₀−1 is set. Otherwise, r₁:=(r-r₀)/α is set. Then, r₁ and r₀ are output.

(HighBits_{q}(r, α) algorithm)

A HighBits_{q}(r, α) algorithm is an algorithm that outputs high-order bits r₁ obtained by breaking up r by α.

Specifically, in the HighBits_{q} (r, α) algorithm, (r₀, r₁) :=Decompose_{q} (r, α) is computed and r₁ is output.

(LowBits_{q} (r, α) algorithm)

A LowBits_{q} (r, α) algorithm is an algorithm that outputs low-order bits r₀ obtained by breaking up r by α.

Specifically, in the LowBits_{q} (r, α) algorithm, (r₀, r₁) :=Decompose_{q} (r, α) is computed and r₀ is output.

(UseHint_{q} (h, r, α) algorithm)

A UseHint_{q} (h, r, α) algorithm recovers the high-order bits of r+z, depending on information of a MakeHint_{q} (z, r, α) algorithm to be described later.

Specifically, in the UseHint_{q} (h, r, α) algorithm, m :=(q−1)/α i set and (r₀, r₁) :=Decompose_{q} (r, α) is computed. If h=1 and r₀>0, (ri+1) mod⁺ m is output. If h=1 and r₀≤0, (r₁−1) mod⁺ m is output.

(MakeHint_{q} (z, r, α) algorithm)

The MakeHint_{q} (z, r, α) algorithm outputs information indicating whether the high-order bits of r change if a small value z is added to r.

Specifically, in the MakeHint_{q} (z, r, a) algorithm, r₁:=HighBits_{q} (r, α) and v₁:=HighBits_{q} (r+z, α) are computed. Then, Formula 33 is output.

### [Formula 33]

[symbol] r₁≠v₁

[symbol]

(Lemma 3)

It is assumed that q and α satisfy q>2α and Formula 34 and that α is an even positive integer. It is assumed that r and z are elements in R_{q}^{<n}, that Formula 35 holds, and that h and h′ are binary vectors.

q≡1 [Formula 34]

∥z∥_{∞}≤α/2 [Formula 35]

In this case, the HighBits_{q} (r, α) algorithm, the UseHint_{q} (h, r, α) algorithm, and the MakeHint_{q} (z, r, α) algorithm satisfy the following properties:

Property 1: UseHint_{q} (MakeHint_{q} (z, r, α), r, α)=HighBits_{q} (r+z, α)

Property 2: Let v₁:=UseHint_{q} (h, r, α), then Formula 36 holds.

∥r−v₁·α∥_{∞}≤α+1 [Formula 36]

Property 3: For any h and h′, if UseHint_{q} (h, r, α)=UseHint_{q}(h′, r, α), then h=h′.

(Lemma 4)

If Formula 37 and Formula 38 hold, then Formula 39 holds.

∥s∥₂₈ ≤β [Formula 37]

∥LowBits_{q}(r,α)∥_{∞}≤α/2−β [Formula 38]

HighBits_{q}(r,α)=HighBits_{q}(r+s,α) [Formula 39]

Operation of Signature System 1

In the following, C denotes a set of polynomials. Elements are such that an L_{∞} norm is 1 and an L₂ norm is restricted so that a polynomial has the min-entropy of λ bits. β,β′, γ,γ′, and δ in the following description are values that are determined taking security into consideration such that they are set to larger values as the security that is set is higher.

<Operation of Key Generation Device 10>

Referring to FIG. 5, operation of the key generation device 10 according to the first embodiment will be described.

The operation of the key generation device 10 according to the first embodiment corresponds to a key generation method according to the first embodiment. The operation of the key generation device 10 according to the first embodiment also corresponds to processes of a key generation program according to the first embodiment.

The key generation device 10 realizes the KeyGen algorithm of the three algorithms of the digital signature.

(Step S11: Acceptance Process)

The acceptance unit 111 accepts input of a security parameter λ.

Specifically, the acceptance unit 111 accepts the security parameter λ input by a user of the key generation device 10 through an operation on an input device. The acceptance unit 111 writes the security parameter λ in the memory 12.

(Step S12: Key generation process)

The key generation unit 112 retrieves the security parameter λ from the memory 12. The key generation unit 112 generates a pair of a secret key sk and a public key pk, using as input the security parameter λ.

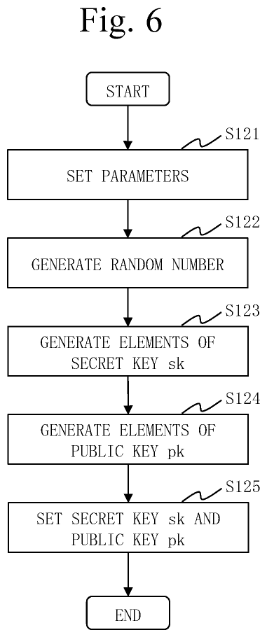

Referring to FIG. 6, a key generation process according to the first embodiment will be described.

(Step S121: Parameter Setting Process)

The key generation unit 112 retrieves the security parameter λ from the memory 12. The key generation unit 112 sets n=n(λ), d=d(λ), k=k(λ), and q=q(λ). That is, n, d, k, and q are values that are determined depending on the security parameter λ.

(Step S122: Random Number Generation Process)

The key generation unit 112 generates a ∈ R_{q}^{<n} uniformly at random.

Specifically, the key generation unit 112 chooses a seed ρ at random, as indicated in Formula 40.

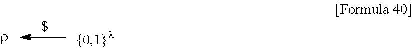

Then, the key generation unit 112 generates a ∈ R_{q}^{<n} with a pseudorandom number generation algorithm, using as input the seed ρ.

(Step S123: Secret Key Element Generation Process)

The key generation unit 112 generates an element s₁ and an element s₂ of the secret key sk uniformly at random, as indicated in Formula 41.

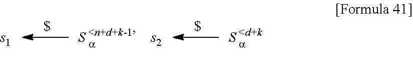

(Step S124: Public Key Element Generation Process)

The key generation unit 112 generates an element to and an element t₁ of the public key pk, as indicated in Formula 42.

t:=α⊙_{d+k}s₁s+₂∈R_{q}^{<d+k},

t₁:=Power2Round_{q}(t, δ)

t₀:=t−t₁·2^{δ}∈ R^{<d+k} [Formula 42]

(Step S125: Key Setting Process)

The key generation unit 112 sets the secret key sk :=(a, s₁, S₂, t₀). The key generation unit 112 sets the public key pk :=(a, t₀, t₁). The key generation unit 112 writes the secret key sk and the public key pk in the memory 12 and in the key storage unit 131.

(Step S13: Transmission Process)

The transmission unit 113 retrieves the secret key sk and the public key pk from the memory 12. The transmission unit 113 transmits the secret key sk to the signature device 20 in secrecy via the communication interface 14 and the communication channel 40. Then, the acceptance unit 211 of the signature device 20 accepts the secret key sk and writes the secret key sk in the key storage unit 231. The transmission unit 113 transmits the public key pk to the verification device 30 via the communication interface 14 and the communication channel 40. Then, the acceptance unit 311 of the verification device 30 accepts the public key pk and writes the public key pk in the key storage unit 331.

Note that to transmit in secrecy means to transmit after encryption by an existing encryption scheme. The secret key sk and the public key pk may be stored in a portable storage medium and then directly transmitted by postal mail or the like. The public key and the secret key may be generated in an external device.

<Operation of Signature Device 20>

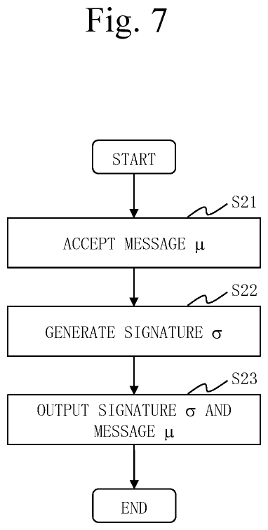

Referring to FIG. 7, operation of the signature device 20 according to the first embodiment will be described.

The operation of the signature device 20 according to the first embodiment corresponds to a signature generation method according to the first embodiment. The operation of the signature device 20 according to the first embodiment also corresponds to processes of a signature generation program according to the first embodiment.

The signature device 20 realizes the Sign algorithm of the three algorithms of the digital signature.

(Step S21: Acceptance Process)

The acceptance unit 211 accepts input of a message Specifically, the acceptance unit 211 accepts the message μ input by a user of the signature device 20 through an operation on an input device. The acceptance unit 211 writes the message μ in the memory 22.

(Step S22: Signature Generation Process)

The signature generation unit 212 retrieves the secret key sk from the key storage unit 231, and retrieves the message μ from the memory 22. The signature generation unit 212 generates a signature σ for the message μ, using as input the secret key sk and the message μ.

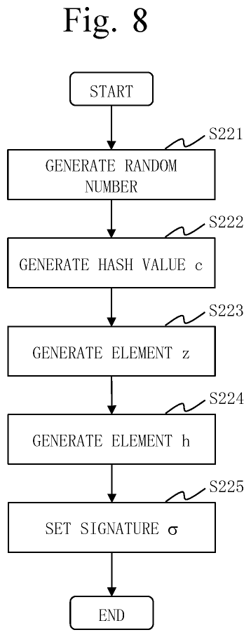

Referring to FIG. 8, a signature generation process according to the first embodiment will be described.

(Step S221: Random Number Generation Process)

The signature generation unit 212 generates a random number y, as indicated in Formula 43.

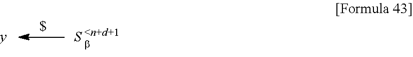

(Step S222: Hash Value c Generation Process)

The signature generation unit 212 generates an element w, as indicated in Formula 44.

a:=α⊙_{d}y ∈ R_{q}^{<d} [Formula 44]

The signature generation unit 212 generates an element wi, as indicated in Formula 45.

w₁:≤HighBits_{q}(w, 2β′) [Formula 45]

The signature generation unit 212 computes a hash value c with a hash function H, using as input the element wi and the message β. That is, c :=H(w₁, μ) ∈ C.

(Step S223: Element z Generation Process)

The signature generation unit 212 generates an element z of the signature σ, using as input the hash value c, the element s₁ of the secret key sk, and the random number y, as indicated in Formula 46.

z:=c⊙_{n+d-1}s₁+y∈ R^{n+d-1} [Formula 46]

That is, the signature generation unit 212 generates the signature element z by computing the middle-product of the hash value c of the message μ and the element s₁ of the secret key sk. More specifically, the signature generation unit 212 generates the signature element z by adding a random value y with a small coefficient to a value obtained by computing the middle-product of the hash value c and the secret key.

(Step S224: Element h Generation Process)

The signature generation unit 212 determines whether Formula 47 or Formula 48 holds.

∥z∥_{∞}≥γ [Formula 47]

∥LowBits_{q}(q−c⊙_{d}s₂, 2β′)∥_{∞≥γ′} [Formula 48]

If Formula 47 or Formula 48 holds, the signature generation unit 212 sets the signature element z and a signature element h as I indicating that the signature cannot be generated, that is, (z, h) :=(⊥, ⊥).

If neither Formula 47 nor Formula 48 holds, the signature generation unit 212 generates the signature element h, as indicated in Formula 49.

h:=MakeHint_{q}(−c⊙_{d}t₀, w−c⊙_{d}s₂+c⊙_{d}t₀, 2β′) [Formula 49]

(Step 5225: Signature Setting Process)

The signature generation unit 212 sets the signature σ:=(h, z, c). The signature generation unit 212 writes the signature 6 in the memory 22.

(Step S23: Output Process)

The output unit 213 outputs the signature σ, including the signature element h, the signature element z, and the hash value c generated by the signature generation unit 212, and the message μ.

Specifically, the output unit 213 transmits the signature σ and the message μ to the verification device 30 via the communication interface 24 and the communication channel 40. Then, the acceptance unit 311 of the verification device 30 accepts the signature σ and the message μ and writes the signature σ and the message μ in the memory 32.

<Operation of Verification Device 30>

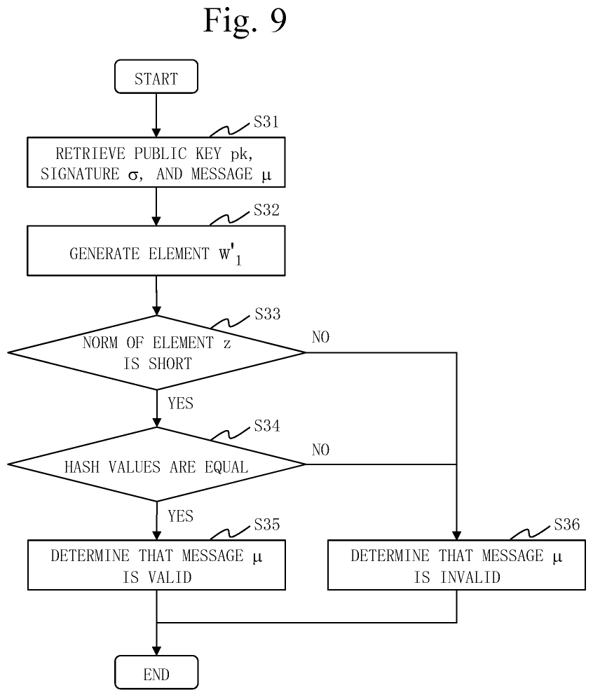

Referring to FIG. 9, operation of the verification device 30 according to the first embodiment will be described.

The operation of the verification device 30 according to the first embodiment corresponds to a verification method according to the first embodiment. The operation of the verification device 30 according to the first embodiment also corresponds to processes of a verification program according to the first embodiment.

The verification device 30 realizes the Verify algorithm of the three algorithms of the digital signature.

(Step S31: Retrieval Process)

The verification unit 312 retrieves the public key pk from the key storage unit 331 and retrieves the signature 6 and the message μ from the memory 32.

(Step S32: Element w′₁ Generation Process)

The verification unit 312 generates an element w′₁, as indicated in Formula 50.

w₁′=UseHint_{q}(h,a⊙_{d}z−c⊙_{d}t₁·2^{δ}, 2β′) [Formula 50]

That is, the verification unit 312 generates the element w′₁ by computing the middle-product of the signature element z included in the signature σ and an element a of the public key pk, and computing the middle-product of the hash value c included in the signature σ and the element t₁ of the public key pk.

(Step S33: Norm Determination Process)

The verification unit 312 determines whether Formula 51 holds.

∥z∥_{∞}<γ [Formula 51]

If Formula 51 holds, the verification unit 312 advances the process to step S34. If Formula 51 does not hold, the verification unit 312 advances the process to step S36.

(Step S34: Hash Value Determination Process)

The verification unit 312 computes a hash value c′ with the hash function H, using as input the element w′₁ and the message μ. That is, c :=H(w′₁, μ). The verification unit 312 determines whether the hash value c included in the signature σ and the computed hash value c′ are equal.

If the hash value c and the hash value c′ are equal, the verification unit 312 advances the process to step S35. If the hash value c and the hash value c′ are not equal, the verification unit 312 advances the process to step S36.

(Step S35: Validity Determination Process)

The verification unit 312 determines that the message μ is valid. That the message μ is valid means that the message μ has not been tampered with and the message μ has been transmitted by the owner of the secret key sk.

Then, the verification unit 312 outputs a value 1 indicating that the message μ is valid.

(Step S36: Invalidity Determination Process)

The verification unit 312 determines that the message μ is invalid. That the message μ is invalid means that the message μ has been tampered with or that the message μ has been transmitted by other than the owner of the secret key sk. Then, the verification unit 312 outputs a value 0 indicating that the message μ is invalid.

The validity of the operation of the verification device 30 will be described.

If the element wi generated in step S222 of FIG. 8 and the element w′₁ generated in step S32 of FIG. 9 are equal, then the hash value c and the hash value c′ are equal. Thus, the equality between the element wi and the element w′₁ will be described here.

The portion corresponding to r in the UseHint_{q} (h, r, a) algorithm of Formula 50 is as indicated in Formula 52.

$$\begin{matrix}a {⊙}_{d} z - c {⊙}_{d} {t}_{1} \cdot {2}^{δ} = a {⊙}_{d} ( c {⊙}_{n + d - 1} {s}_{1} + y ) - \\ c {⊙}_{d} ( t - {t}_{0} ) \\ = a {⊙}_{d} c {⊙}_{n + d - 1} {s}_{1} + a {⊙}_{d} y - \\ c {⊙}_{d} t + c {⊙}_{d} {t}_{0} \\ = a {⊙}_{d} c {⊙}_{n + d - 1} {s}_{1} + a {⊙}_{d} y - \\ c {⊙}_{d} ( a {⊙}_{d + k} {s}_{1} + {s}_{2} ) + c {⊙}_{d} {t}_{0} \\ = a {⊙}_{d} c {⊙}_{n + d - 1} {s}_{1} + a {⊙}_{d} y - \\ c {⊙}_{d} a {⊙}_{d + k} {s}_{1} + c {⊙}_{d} {s}_{2} + \\ c {⊙}_{d} {t}_{0} \\ = a {⊙}_{d} y + c {⊙}_{d} {s}_{2} + c {⊙}_{d} {t}_{0} \\ = w + c {⊙}_{d} {s}_{2} + c {⊙}_{d} {t}_{0}\end{matrix} \qquad \{ Formula 52 ]$$

The first line is modified to the second line in Formula 52, based on z and ti indicated in Formula 53.

z=(c⊙_{n+d-1}s₁+y),

t₁·2^{δ}=t−t₀ [Formula 53]

The second line is modified to the third line in Formula 52 by expanding the parentheses.

The third line is modified to the fourth line in Formula 52 by substitution with t indicated in Formula 54.

t=α⊙_{d+k}s₁+s₂ [Formula 54]

The fourth line is modified to the fifth line in Formula 52 by expanding the parentheses.

The fifth line is modified to the sixth line in Formula 52 by canceling Formula 55 and Formula 56 in Formula 52. Note that Formula 55 and Formula 56 can be canceled based on Lemma 2.

a└_{d}c⊙_{n+d-1}s₁ [Formula 55]

−c⊙a⊙_{d+k}s₁ [Formula 56]

The sixth line is modified to the seventh line in Formula 52, based on Formula 57.

w=a⊙_{d}y [Formula 57]

Next, Formula 50 is expressed as indicated in Formula 58.

$$\begin{matrix}{w}_{1}^{′} = {UseHint}_{q} ( h , a {⊙}_{d} z - c {⊙}_{d} {t}_{1} \cdot {2}^{δ} , 2 {β}^{′} ) \\ = {HighBits}_{q} ( w - c {⊙}_{d} {s}_{2} - c {⊙}_{d} {t}_{0} + c {⊙}_{d} {t}_{0} , 2 {β}^{′} ) \\ = {HighBits}_{q} ( w - c {⊙}_{d} {s}_{2} , 2 {β}^{′} ) \\ = {HighBits}_{q} ( w , 2 {β}^{′} ) \\ = {w}_{1}\end{matrix} \qquad [ Formula 58 ]$$

Note that z, r, and a in UseHint_{q} (MakeHint_{q} (z, r, α), r, α)=HighBits_{q} (r+z, α) indicated in Property 1 of Lemma 3 are as indicated in Formula 59.

z=−c⊙_{d}t₀,

r=w−c⊙_{d}d₂+c⊙_{d}t₀,

α=2β′ [Formula 59]

This is because the portion corresponding to r in the UseHint_{q} (h, r, α) algorithm is Formula 60, as indicated in Formula 52, and the signature element h is generated as indicated in Formula 61 in step S224 of FIG. 8.

a⊙_{d}z−c⊙_{d}t₁·2^{δ}=w−c⊙_{d}s₂+c⊙_{d}t₀ [Formula 60]

MakeHint_{q}(−c⊙_{d}t₀, w−c⊙_{d}s₂+c⊙_{d}t₀, 2β′) [Formula 61]

Thus, the first line is modified to the second line in Formula 58.

The second line is modified to the third line in Formula 58 by canceling Formula 62 and Formula 63.

−c⊙_{d}t₀ [Formula 62]

c⊙_{d}s₂ [Formula 63]

Formula 63 in the third line of Formula 58 is a small value. For this reason, it can be ignored in the HighBits_{q} (r, α) algorithm that outputs high-order bits. Therefore, the third line is modified to the fourth line in Formula 58.

Effects of First Embodiment

As described above, in the signature system 1 according to the first embodiment, the signature device 20 generates the signature element z, which is an element of the signature 6, by computing the middle-product of the hash value c of the message μ and the element s₁ of the secret key sk. The verification device 30 verifies the signature σ by computing the middle-product of the signature element z, which is an element of the signature σ, and the element a of the public key pk, and computing the middle-product of the hash value c, which is an element of the signature σ, and the element t₁ of the public key pk.

This allows the security to be based on the MPLWE assumption, and makes it possible to allow construction of a digital signature scheme whose security can be guaranteed even against a quantum computer.

Other Configurations

<First Variation>

In the first embodiment, the functional components are realized by software.

However, as a first variation, the functional components may be realized by hardware. With regard to this first variation, differences from the first embodiment will be described.

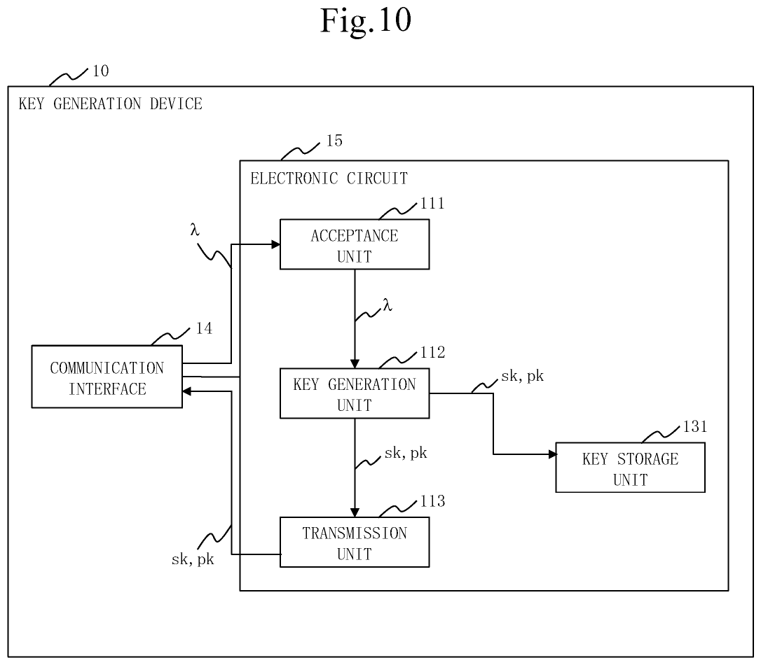

Referring to FIG. 10, a configuration of the key generation device 10 according to the first variation will be described.

When the functional components are realized by hardware, the key generation device 10 includes an electronic circuit 15 in place of the processor 11, the memory 12, and the storage 13. The electronic circuit 15 is a dedicated circuit that realizes the functions of the functional components, the memory 12, and the storage 13.

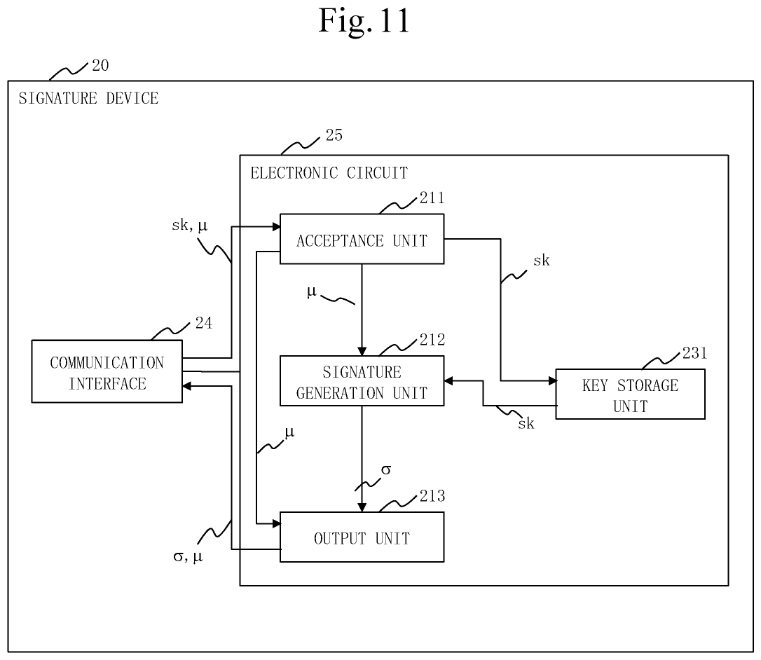

Referring to FIG. 11, a configuration of the signature device 20 according to the first variation will be described.

When the functional components are realized by hardware, the signature device 20 includes an electronic circuit 25 in place of the processor 21, the memory 22, and the storage 23. The electronic circuit 25 is a dedicated circuit that realizes the functions of the functional components, the memory 22, and the storage 23.

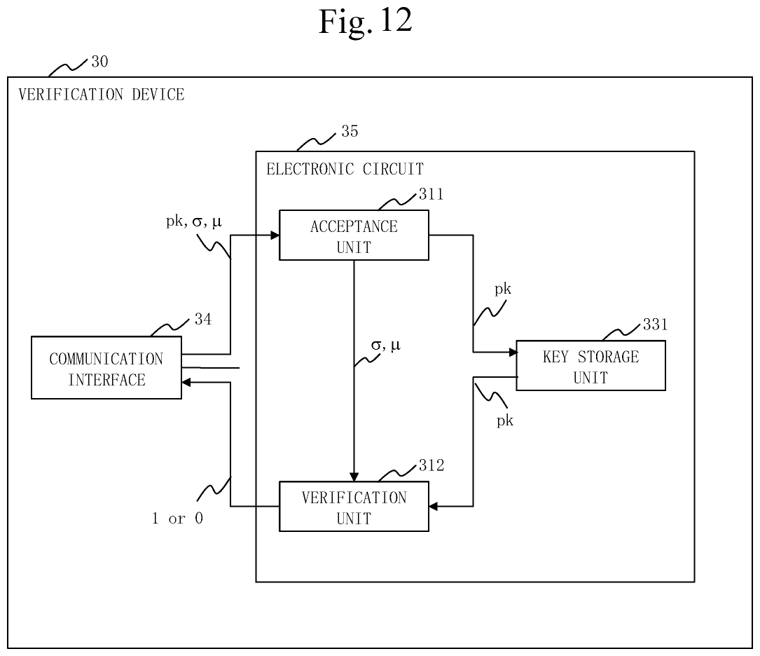

Referring to FIG. 12, a configuration of the verification device 30 according to the first variation will be described.

When the functional components are realized by hardware, the verification device 30 includes an electronic circuit 35 in place of the processor 31, the memory 32, and the storage 33. The electronic circuit 35 is a dedicated circuit that realizes the functions of the functional components, the memory 32, and the storage 33.

Each of the electronic circuits 15, 25, and 35 is assumed to be a single circuit, a composite circuit, a programmed processor, a parallel-programmed processor, a logic IC, a gate array (GA), an application specific integrated circuit (ASIC), or a field-programmable gate array (FPGA).

The respective functional components may be realized by one electronic circuit 15, one electronic circuit 25, and one electronic circuit 35, or the respective functional components may be distributed among and realized by a plurality of electronic circuits 15, a plurality of electronic circuits 25, and a plurality of electronic circuits 35.

<Second Variation>

As a second variation, some of the functional components may be realized by hardware, and the rest of the functional components may be realized by software.

Each of the processors 11, 21, 31, the memories 12, 22, 32, the storages 13, 23, 33, and the electronic circuits 15, 25, 35 is referred to as processing circuitry. That is, the functions of the functional components are realized by the processing circuitry.

### REFERENCE SIGNS LIST

1: signature system, 10: key generation device, 11: processor, 12: memory, 13: storage, 14: communication interface, 15: electronic circuit, 111: acceptance unit, 112: key generation unit, 113: transmission unit, 131: key storage unit, 20: signature device, 21: processor, 22: memory, 23: storage, 24: communication interface, 25: electronic circuit, 211: acceptance unit, 212: signature generation unit, 213: output unit, 231: key storage unit, 30: verification device, 31: processor, 32: memory, 33: storage, 34: communication interface, 35: electronic circuit, 311: acceptance unit, 312: verification unit, 331: key storage unit, 40: communication channel

1. A signature device comprising:
processing circuitry to:
generate a signature element z by computing a middle-product of a hash value c of a message μ and a secret key; and
output a signature σ including the generated signature element z.

2. The signature device according to claim 1,
wherein the processing circuitry generates the signature element z by adding a random value y having a small coefficient to a value obtained by computing the middle-product of the hash value c and the secret key.

3. The signature device according to claim 2,
wherein the processing circuitry generates a signature σ including a signature element h, the signature element z, and the hash value c indicated in Formula 1
h:=MakeHint_{q}(−c⊙_{d}t₀, w−c⊙_{d}s₂+c⊙_{d}t₀, 2β′),
z:=c⊙_{n+d-1}s₁+y,
c:=H(w₁, μ) [Formula 1]
where
n, d, β′ are values that arc set depending on security,
y is a random number,
α, s₁, s₂, t₀ are elements of the secret key,
w:=α ⊙_{d}y,
w₁:=highBits_{q}(w, 2β′)
μ is a message, and
H is a hash function.

4. A verification device comprising:
processing circuitry to:
accept a signature 6 including a signature element z; and
verify the signature 6 by computing a middle-product of the accepted signature element z and a public key.

5. The verification device according to claim 4, wherein the processing circuitry accepts a signature σ including the signature element z generated by computing a middle-product of a hash value c of a message β and a secret key and including the hash value c, and
verifies the signature σ by computing a hash value c′, using as input a value w′₁, obtained by computing the middle-product of the signature element z and the public key, and the message and determining whether a match occurs between the computed hash value c′ and the hash value c included in the signature σ.

6. The verification device according to claim 4,
wherein the public key is generated by computing a middle-product of a random polynomial a and a secret key.

7. The verification device according to claim 5,
wherein the public key is generated by computing a middle-product of a random polynomial a and a secret key.

8. The verification device according to claim 5, wherein the processing circuitry accepts the signature 6 including a signature element h, the signature element z, and the hash value c indicated in Formula 2, and
computes the value w′₁, as indicated in Formula 3
h:=MakeHint_{q}(−c⊙_{d}t₀, w−c⊙_{d}s₂+c⊙_{d}t₀, 2β′),
z:=c⊙_{n+d}−1s₁+y,
c:=H(w₁, μ)
where
m,d,β′, are values that are set depending on security,
Y is a random number,
a, s₁, s₂, t₀ are elements offhe secret key,
w:=α⊙_{d}y,
w₁:=HighBits_{q}(w, 2β′)
μ is a message, and
H is a hash function,
w₁′=UseHint_{q}(h, a⊙_{d}z−c⊙_{d}t₁·2^{δ}, 2β′) [Formula 3]
where
δ is a value that is set depending on security, and
a, t₁ are elements of the public key.

9. A signature system comprising:
a signature device to generate a signature element z by computing a middle-product of a hash value c of a message μ and a secret key, and output a signature σ including the signature element z; and
a verification device to verify the signature σ by computing a middle-product of the signature element z generated by the signature device and a public key.

10. A signature method comprising:
generating a signature element z by computing a middle-product of a hash value c of a message μ and a secret key; and
outputting a signature σ including the signature element z.

11. A non-transitory computer readable medium storing a signature program that causes a computer to function as a signature device to perform:
a signature generation process of generating a signature element z by computing a middle-product of a hash value c of a message μ and a secret key; and
an output process of outputting a signature σ including the signature element z generated by the signature generation process.

12. A verification method comprising:
accepting a signature σ including a signature element z; and
verifying the signature σ by computing a middle-product of the signature element z and a public key.

13. A non-transitory computer readable medium storing a verification program that causes a computer to function as a verification device to perform:
an acceptance process of accepting a signature σ including a signature element z; and
a verification process of verifying the signature σ by computing a middle-product of the signature element z accepted by the acceptance process and a public key.
